(19) United States
(12) Patent Application Publication
(10) Pub. No.: US 2025/0384618 A1
(43) Pub. Date: Dec. 18, 2025

(54) EFFICIENT RENDERING METHOD FOR COMPLEX SCENES BASED ON VISUAL PERCEPTION RADIATION FIELDS

(71) Applicant: Beihang University, Beijing (CN)

(72) Inventors: Lili WANG, Beijing (CN); Zijun Wang, Beijing (CN); Jian Wu, Beijing (CN); Qinping Zhao, Beijing (CN)

(21) Appl. No.: 19/001,471

(22) Filed: Dec. 25, 2024

(30) Foreign Application Priority Data
Jun. 14, 2024 (CN) 202410772911.X

(51) Int. Cl. G06T 15/08; G06F 3/01; G06V 10/46; G06V 10/56

(52) U.S. Cl. CPC G06T 15/08; G06F 3/013; G06V 10/462; G06V 10/56

(57) ABSTRACT

Embodiments of this disclosure disclose an efficient rendering method for complex scenes based on visual perception radiation fields. One specific mode of carrying out this method comprises: constructing an initial visual perception radiation field; selecting a scene image as a sample image, and performing the following steps: generating a visual sampling rate map; determining an image rendering result based on the visual sampling rate map and the initial visual perception radiation field; determining a target difference value between the image rendering result and rendering data of the sample image; in response to determining that the target difference value is less than a preset difference threshold, determining the initial visual perception radiation field, which has completed training, as a visual perception radiation field; inputting rendering perspective information into the visual perception radiation field to output a target rendered image; controlling a display device to display the target rendered image.

### CROSS-REFERENCE TO RELATED APPLICATION

This application claims priority from the Chinese patent application 202410772911.X filed Jun. 14, 2024, the content of which is incorporated herein in the entirety by reference.

### TECHNICAL FIELD

Embodiments of this disclosure relate to the fields of computer graphics and virtual reality, and specifically to an efficient rendering method for complex scenes based on visual perception radiation fields.

### BACKGROUND

In virtual reality scenes, image rendering performance has a significant influence on the efficiency of synthesizing new perspective images. At present, a commonly used method for image rendering is: a method of using a neural radiation field or neural radiation field variant based on multilayer perceptron to render and synthesize new perspective images based on the geometric information (such as depth, opacity) of virtual reality scenes and the characteristics of the central visual area.

However, in practice, it has been found that when using the above method for image rendering, there are often the following technical issues:
Firstly, the neural radiation field and its variant method usually requires a rather long period of network inference during training and operation, and is prone to ignoring significant features around the central visual area, which results in a longer rendering process and lower rendering quality, thereby making it difficult to generate new perspective images of higher quality in a timely manner;
Secondly, the neural radiation field and its variant method typically uses uniform sampling or first coarse then fine sampling to sample points on light rays. The uniform sampling may easily lead to undersampling in visually salient areas, while the first coarse then fine sampling may easily result in oversampling in some visually salient areas, so the quality of the new perspective images synthesized based on the sampled points may easily be rendered rather low.

The information disclosed above is only for enhancing the understanding of the background of the conception of this disclosure, so it may contain information that does not constitute the existing art known to a person having ordinary skill in the art in this country.

### SUMMARY

The content of this disclosure is to briefly introduce conceptions, which will be described in detail in the section of detailed description of the invention later. The content of this disclosure is not intended to identify key or necessary features of the claimed technical solution, nor is it intended to limit the scope of the claimed technical solution.

Some embodiments of this disclosure propose an efficient rendering method for complex scenes based on visual perception radiation fields to solve one or more of the technical problems mentioned in the background section above.

Some embodiments of this disclosure provide an efficient rendering method for complex scenes based on visual perception radiation fields, the method comprising: based on a scene image set obtained in advance corresponding to a target 3D (Three Dimensional) scene, constructing an initial visual perception radiation field, wherein each scene image in the scene image set corresponds to a visual sensitivity image in a visual sensitivity image set, the initial visual perception radiation field includes an initial density grid, an initial color grid, and an initial visual saliency grid; selecting a scene image from the scene image set as a sample image, and based on the selected sample image, performing the following initial visual perception radiation field training steps: based on user gaze point information corresponding to the selected sample image, as well as the initial density grid and initial visual saliency grid included in the initial visual perception radiation field, generating a visual sampling rate map; based on the visual sampling rate map, and the initial density grid and initial color grid included in the initial visual perception radiation field, determining an image rendering result corresponding to the sample image; based on a preset loss function group, determining a target difference value between the image rendering result corresponding to the sample image and rendering data of the sample image, wherein the rendering data of the sample image includes the sample image and the visual sensitivity image corresponding to the sample image; in response to determining that the target difference value is less than a preset difference threshold, determining the initial visual perception radiation field, which has completed training, as a visual perception radiation field; inputting the preset rendering perspective information into the visual perception radiation field to output a target rendered image corresponding to the target 3D scene; controlling an associated display device to display the target rendered image.

The embodiments of this disclosure have the following beneficial effects: through the efficient rendering method for complex scenes based on visual perception radiation fields in some embodiments of this disclosure, the efficiency and quality of image rendering may be improved, and new perspective images of higher quality may be generated in a timely manner. To be specific, the reason why it is difficult to generate new perspective images of higher quality in a timely manner is that: the neural radiation field and its variant method usually requires a rather long period of network inference during training and operation, and is prone to ignoring significant features around the central visual area, which results in a longer rendering process and lower rendering quality. On this basis, some embodiments of this disclosure propose an efficient rendering method for complex scenes based on visual perception radiation fields. First, construct an initial visual perception radiation field based on a scene image set obtained in advance corresponding to a target 3D scene, wherein each scene image in the scene image set corresponds to a visual sensitivity image in a visual sensitivity image set, the initial visual perception radiation field includes an initial density grid, an initial color grid, and an initial visual saliency grid. Thus, an untrained initial visual perception radiation field based on a grid structure corresponding to the target 3D scene may be constructed. Then, select a scene image from the scene image set as a sample image, and based on the selected sample image, perform the following initial visual perception radiation field training steps: generate a visual sampling rate map based on the user gaze point information corresponding to the selected sample image, as well as the initial density grid and initial visual saliency grid included in the initial visual perception radiation field; based on the visual sampling rate map, and the initial density grid and initial color grid included in the initial visual perception radiation field, determine an image rendering result corresponding to the sample image; based on a preset loss function group, determine a target difference value between the image rendering result corresponding to the sample image and the rendering data of the sample image, wherein the rendering data of the sample image includes the sample image and the visual sensitivity image corresponding to the sample image; in response to determining that the target difference value is less than a preset difference threshold, determine the initial visual perception radiation field, which has completed training, as a visual perception radiation field. Thus, the initial visual perception radiation field may be trained from sample images of multiple perspectives to obtain a visual perception radiation field with higher image rendering quality. Wherein, when training the initial visual perception radiation field based on each sample image, a visual sampling rate corresponding to each pixel in the image to be rendered may be generated based on the sensitivity and gaze point information of the human eye to the scene content. The initial density grid and initial color grid may be sampled based on the visual sampling rate corresponding to each pixel, and a predicted image rendering results may be generated further on the basis of the sampling results. Thereafter, input the preset rendering perspective information into the visual perception radiation field to output a target rendered image corresponding to the target 3D scene. Thus, a new perspective image corresponding to the target 3D scene may be generated through visual perception radiation field. In the end, control an associated display device to display the target rendered image. Therefore, the efficient rendering method for complex scenes based on visual perception radiation fields in some embodiments of this disclosure may sample a relatively limited number of grids for image rendering during training and operation by constructing in advance a visual perception radiation field based on a grid structure, without spending a rather long time on network inference, thereby shortening the time for image rendering. Moreover, the visual sampling rate used for ray sampling is determined based on visual sensitivity and gaze point information, which may thus reduce the possibility of the high visual sensitivity area around the gaze point being ignored and improve image rendering quality. Thus, new perspective images of higher quality may be generated in a timely manner.

### BRIEF DESCRIPTION OF THE DRAWINGS

The above and other features, advantages, and aspects of the embodiments of this disclosure will become more apparent in conjunction with the accompanying drawings and with reference to the following specific implementations. Throughout the drawings, the same or similar reference signs indicate the same or similar elements. It should be understood that the drawings are schematic, and the components and elements are not necessarily drawn to scale.

FIG. 1 is a flowchart of some embodiments of an efficient rendering method for complex scenes based on visual perception radiation fields according to this disclosure;

FIG. 2 is a schematic diagram made up of the visual sensitivity map and the contrast sensitivity map generated from a specific perspective, as well as the visual sampling rate map generated by mixing the two, of the efficient rendering method for complex scenes based on visual perception radiation fields according to this disclosure.

### DETAILED DESCRIPTION OF THE INVENTION

Hereinafter, the embodiments of this disclosure will be described in more detail with reference to the accompanying drawings. Although certain embodiments of this disclosure are shown in the drawings, it should be understood that this disclosure may be implemented in various forms, and shall not be construed as being limited to the embodiments set forth herein. On the contrary, these embodiments are provided for a more thorough and complete understanding of this disclosure. It should be understood that the drawings and embodiments of this disclosure are used only for illustrative purposes, not to limit the protection scope of this disclosure.

Besides, it should be noted that, for ease of description, only the portions related to the relevant invention are shown in the drawings. In the case of no conflict, the embodiments in this disclosure and the features in the embodiments may be combined with each other.

It should be noted that such concepts as “first” and “second” mentioned in this disclosure are only used to distinguish different devices, modules or units, and are not used to limit the order of functions performed by these devices, modules or units or interdependence thereof.

It should be noted that such adjuncts as “one” and “more” mentioned in this disclosure are illustrative, not restrictive, and those skilled in the art should understand that, unless the context clearly indicates otherwise, they should be understood as “one or more”.

The names of messages or information exchanged between multiple devices in the embodiments of this disclosure are only for illustrative purposes, and are not intended to limit the scope of these messages or information.

This disclosure will be described in detail below with reference to the accompanying drawings and in conjunction with embodiments.

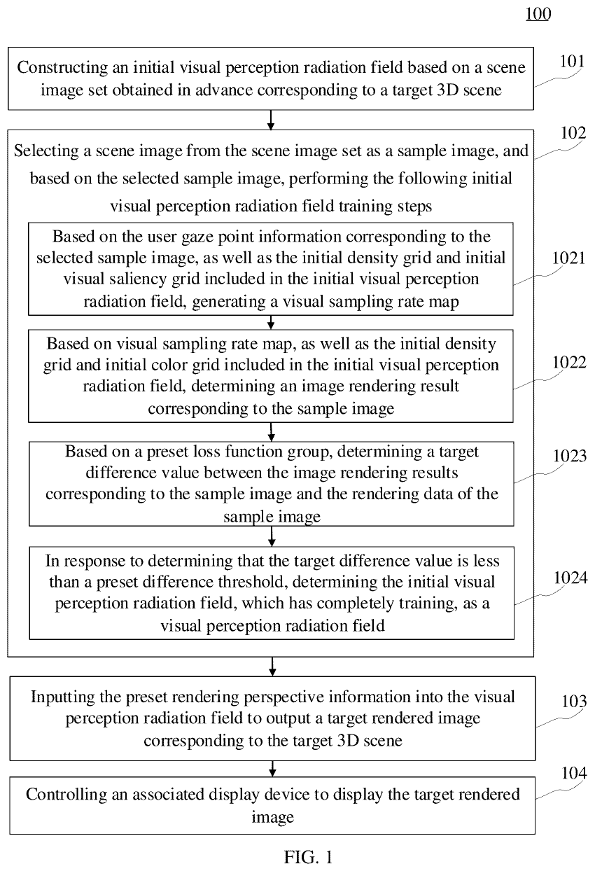

FIG. 1 illustrates a process 100 of some embodiments of an efficient rendering method for complex scenes based on visual perception radiation fields according to this disclosure. The efficient rendering method for complex scenes based on visual perception radiation fields comprises the following steps:
Step 101: Constructing an initial visual perception radiation field based on a scene image set obtained in advance corresponding to a target 3D scene.

In some embodiments, the executing body (such as a computing device) of the efficient rendering method for complex scenes based on visual perception radiation fields may construct, by various means, an initial visual perception radiation field based on a scene image set obtained in advance corresponding to a target 3D scene. Wherein, the complex scene may be a scene that includes many objects with complex features. The complex features may include but are not limited to complex textures or complex lighting. The target 3D scene may be a complex 3D scene of a new perspective image to be synthesized. The new perspective scene image may be an image of a new perspective position that is different from the original perspective. The scene image set may be a collection of scene images from different perspectives. The scene image may be an RGB (Red, Green, Blue) image corresponding to the target 3D scene. Each scene image in the scene image set may correspond one-to-one with the visual sensitivity images in the visual sensitivity image set generated in advance. The visual sensitivity images in the visual sensitivity image set may be grayscale images generated in advance characterizing the visual saliency and contour features of the corresponding scene images. The visual saliency may characterize the degree to which objects in an image receive visual attention from an observer. The initial visual perception radiation field may include an initial density grid, an initial color grid, and an initial visual saliency grid. The initial density grid, initial color grid, and initial visual saliency grid may be constructed based on pre-generated voxel grids on different feature dimensions. Wherein, the voxel grid may be composed of various sub-voxel grids. The sub-voxel grids may be grids obtained by uniformly dividing the entire 3D scene according to voxels. Each grid may contain 3D spatial points at the corresponding voxel position. For example, when the voxel grid is 128*128*128 in size, the sub-voxel grid is 1*1*1 in size. Each sub-voxel grid is associated with a sub-grid identifier. The sub-grid identifier may be a unique identifier for the corresponding sub-voxel grid. Each sub-voxel grid may store the various feature values of a corresponding voxel at its corresponding position in the scene. The various feature values may include but are not limited to density values, color feature values, and visual sensitivity feature values.

In addition, the density values may characterize the probability of an object existing within the corresponding sub-voxel grid in the 3D scene. The density values may be obtained by trilinear interpolation based on the nearest 8 sub-voxel grids of the corresponding sub-voxel grid. The color feature values may characterize the color of the corresponding voxel at the corresponding position in the scene. The color feature values may be represented by color vector groups. Each color vector in the color vector group corresponds one-to-one with the color channel of the RGB image. Each color vector may characterize the color information of the corresponding voxel stored in the corresponding color channel at the corresponding position in the scene. Each color vector may be composed of 9 spherical harmonic coefficients. Color information may be modeled using a second-order spherical harmonic function, and 9 spherical harmonic coefficients may be determined for each color channel. The visual sensitivity feature values may characterize the visual sensitivity of a corresponding voxel at the corresponding position in the scene. The visual sensitivity may characterize the degree to which the corresponding voxel receives visual attention from an observer in the corresponding perspective. The visual sensitivity feature values may be represented by a visual sensitivity vector. The visual sensitivity vector may be composed of 4 spherical harmonic coefficients. Visual sensitive information may be modeled using a first-order spherical harmonic function and solved to obtain 4 spherical harmonic coefficients. The initial density grid may include a sub-initial density grid set. Each sub-initial density grid corresponds one-to-one with the sub-voxel grids in the various sub-voxel grids above. Each sub-initial density grid may be a grid that stores the density value of a corresponding sub-voxel grid. The initial color grid may include a sub-initial color grid set. Each sub-initial color grid corresponds one-to-one with the sub-voxel grids in the various sub-voxel grids. Each sub-initial color grid may be a grid that stores the color feature value of a corresponding sub-voxel grid. The initial visual saliency grid may include a sub-initial visual saliency grid set. Each sub-initial visual saliency grid corresponds one-to-one with the sub-voxel grids in the various sub-voxel grids. Each sub-initial visual saliency grid may be a grid that stores the visual sensitivity feature value of a corresponding sub-voxel grid.

In certain optional implementations of some embodiments, the executing body may construct an initial visual perception radiation field based on a scene image set obtained in advance corresponding to a target 3D scene through the following steps:

The first step is to construct a 3D voxel model based on the scene image set. Wherein, the 3D voxel model may be a model that represents the target 3D scene through voxel grids. A 3D voxel model may be constructed based on the scene image set using a preset voxel model construction method. For example, the voxel model construction method may be, but is not limited to, at least one of the following: voxel model construction method based on feature representation learning, voxel model generation method based on graph convolution.

The second step is to determine a first feature grid, a second feature grid, and a third feature grid corresponding to the 3D voxel model. Wherein, the first feature grid, second feature grid, and third feature grid may have the same structure as the 3D voxel model. The first feature grid may be a grid used only to store the various density values corresponding to each sub-voxel grid. The second feature grid may be a grid used only to store the various color feature values corresponding to each sub-voxel grid. The third feature grid may be a grid used only to store the various visual sensitivity feature values corresponding to each sub-voxel grid. Based on the feature values, the voxel grid corresponding to the 3D voxel model may be dimensionally split to obtain a first feature grid, a second feature grid, and a third feature grid.

The third step is to initialize the feature values of the first feature grid to obtain an initial density grid. Each density value in the first feature grid may be initialized into a random density value. Wherein, the random density value may be a random number between 0-1 generated by a random generator. Then, the first feature grid after initialization is determined as an initial density grid.

The fourth step is to initialize the feature values of the second feature grid to obtain an initial color grid. Each color feature value in the second feature grid may be initialized into a random color feature value. Wherein, the random color feature value may be a randomly generated color vector group. For each color vector in the color vector group to be generated, a random generator may be used to generate 9 random numbers between 0-1 to form a color vector. Then, the second feature grid after initialization is determined as an initial color grid.

The fifth step is to initialize the feature values of the third feature grid to obtain an initial visual saliency grid. Each visual sensitivity feature value in the third feature grid may be initialized into a random visual sensitivity value. Wherein, the random visual sensitivity value may be a visual sensitivity vector composed of 4 random numbers between 0-1. Then, the third feature grid after initialization is determined as an initial visual saliency grid.

The sixth step is to determine the model represented by the initial density grid, initial color grid, and initial visual saliency grid as an initial visual perception radiation field.

Alternatively, the visual sensitivity image set may be generated in advance through the following steps:

For each scene image in the scene image set, perform the following steps to generate a visual sensitivity image in the visual sensitivity image set:

The first step is to perform edge detection on the scene image using a preset edge detection algorithm to obtain a first grayscale image. Wherein, the first grayscale image may be a grayscale image of the same size as the scene image. For example, the edge detection algorithm may be, but is not limited to, one of the following: Sobel operator, Canny operator.

The second step is to perform visual saliency detection on the scene image using a preset visual saliency detection algorithm to obtain a second grayscale image. Wherein, the second grayscale image may be a grayscale image of the same size as the scene image. For example, the visual saliency detection algorithm may be, but is not limited to, one of the following: FT (Frequency tuned) algorithm, residual spectrum algorithm.

The third step is to fuse the first grayscale image and the second grayscale image to obtain a visual sensitivity image. Wherein, the pixel values at the same position in two grayscale images may be added together, the result obtained serve as the pixel value of the corresponding position in the visual sensitivity image.

Step 102: Selecting a scene image from the scene image set as a sample image, and based on the selected sample image, performing the following initial visual perception radiation field training steps:

Step 1021: Based on the user gaze point information corresponding to the selected sample image, as well as the initial density grid and initial visual saliency grid included in the initial visual perception radiation field, generating a visual sampling rate map.

In some embodiments, the executing body may generate, by various means, a visual sampling rate map based on the user gaze point information corresponding to the selected sample image, as well as the initial density grid and initial visual saliency grid included in the initial visual perception radiation field. Wherein, the user gaze point information may be the information obtained in advance about the position of the user gaze point on the corresponding sample image. The user gaze point may be obtained through an eye tracking device. The Eye tracking device may be used to measure and record eye position and movement. For example, the eye tracking device may be an eye tracker. The visual sampling rate map may be a grayscale image with visual sampling rate as the pixel value. The visual sampling rate may be the sampling rate when sampling along the ray. The sampling rate may be represented by a numerical value between 0-1. Wherein, 1 represents the highest sampling rate, and 0 represents the lowest sampling rate. When the visual sampling rate is relatively high, dense sampling is performed along the ray; when the visual sampling rate is relatively low, sparse sampling is performed along the ray.

In certain optional implementation methods of some embodiments, the executing body may generate, through the following steps, a visual sampling rate map based on the user gaze point information corresponding to the selected sample image, as well as the initial density grid and initial visual saliency grid included in the initial visual perception radiation field:

The first step is to construct a visual sensitivity map based on the user gaze point information corresponding to the sample image, the image resolution information corresponding to a preset camera image, and the corresponding camera field angle information. Wherein, the camera image may be a predicted RGB image to be captured by the camera. The image resolution information may be the information of the horizontal resolution and vertical resolution of the camera image. The image resolution information may be represented using a one-dimensional vector consisting of the horizontal resolution and vertical resolution corresponding to the camera image. It should be noted that the image resolution information is also the resolution information of the sample image mentioned above. The camera field angle information may be the information of the horizontal field angle and vertical field angle when the camera shoots the sample image. The camera field angle information may be represented by a one-dimensional vector consisting of the camera's horizontal field angle and vertical field angle. Each pixel in the camera image may correspond one-to-one with each ray in a preset ray set. Each ray in the ray set may characterize the ray passing through the target 3D scene. Each ray is associated with a unique corresponding number. The visual sensitivity map has the same resolution as the camera image. Each pixel in the visual sensitivity map represents the visual sensitivity by storing a numerical value of 0-1. Each visual sensitivity in the visual sensitivity map may characterize the importance of the corresponding pixel in the camera image. The visual sensitivity in the visual sensitivity map may be generated using the following formula set:

$$\{ \begin{matrix}s = ( d / 2 ) / tan ( a / 2 ) \\ f = a tan ( \vert F - ( d / 2 ) \vert / s ) \\ g = a tan ( \vert G - ( d / 2 ) \vert / s ) \\ e = \sqrt{{( {f}_{x} - {g}_{x} )}^{2} + {( {f}_{y} - {g}_{y} )}^{2}} \\ V = {ω}_{0} + m \times e\end{matrix} .$$

Wherein, V represents visual sensitivity, ω₀ represents the lower limit value of visual sensitivity, m represents the slope of visual acuity, the slope of visual sensitivity represents the magnitude of the change in visual sensitivity with the variation of eccentricity, F represents the coordinates of the ray corresponding to the pixel, G represents the coordinates of the user gaze point, e represents the eccentricity of the pixel corresponding to the ray relative to the user gaze point, s represents the distance from the user gaze point to the imaging screen, the imaging screen is the screen of the display where the camera image is located, a/2 represents a one-dimensional vector consisting of ½ of the horizontal field angle and ½ of the vertical field angle, the a in a/2 represents the vector corresponding to the camera field angle information, d/2 represents the center point position of the imaging screen, the d in d/2 represents the vector corresponding to the image resolution information, tan(·) represents the tangent function, atan(·) represents the arctangent function, f represents the eccentricity of the pixel corresponding to the ray relative to the center point of the imaging screen, g represents the eccentricity of the user gaze point relative to the center point of the imaging screen, x represents the horizontal direction, y represents the vertical direction, fₓ represents the component of eccentricity f in the direction x, f_{y} represents the component of eccentricity f in the direction y, gₓ represents the component of eccentricity g in the direction x, g_{y} represents the component of eccentricity g in the direction y.

The second step is to construct an initial contrast sensitivity map based on the aforementioned ray set, as well as the initial density grid and initial visual saliency grid included in the initial visual perception radiation field. Wherein, the initial contrast sensitivity map may be a grayscale image with a resolution lower than that of the camera image. The initial contrast sensitivity map may characterize the distribution of the initial contrast sensitivity corresponding to each pixel in the scene image. Each pixel value in the initial contrast sensitivity map may characterize the initial contrast sensitivity. Each pixel value in the initial contrast sensitivity map may range from 0 to 1. The initial contrast sensitivity may characterize the level of sensitivity of human vision to the pixels in a scene image. For example, there is a simple scene where an apple is placed in the middle of a white room, then the human vision is more sensitive to this apple. Therefore, the initial contrast sensitivity of the pixel position where the apple is placed may approach 1, and the initial contrast sensitivity of the pixels corresponding to the background white room may approach 0.

In certain optional implementations of some embodiments, the executing body may construct an initial contrast sensitivity map based on the aforementioned ray set, as well as the initial density grid and initial visual saliency grid included in the initial visual perception radiation field through the following steps:

Step 1: For each ray in the ray set, perform the following steps:

Sub-step 1: Determine the pixel in the camera image that corresponds to the aforementioned ray as a target pixel.

Sub-step 2: Uniformly sample the points on the aforementioned ray to obtain an initial sampling point sequence. Wherein, the points on the ray may be 3D spatial points in the scene. Each spatial point is associated with a spatial point identifier. The spatial point identifier may be a unique identifier of the spatial point. The initial sampling point sequence may be an ordered set of sampling points obtained by uniformly sampling along the direction of the ray for the first time, targeting points on the ray. Based on a preset sampling interval, the points on the ray may be uniformly sampled to obtain an initial sampling point sequence. Wherein, the preset sampling interval may be the interval between two adjacent sampling points set in advance.

Sub-step 3: Based on the initial density grid included in the initial visual perception radiation field, determine a sampling point density value corresponding to each initial sampling point in the initial sampling point sequence, to obtain a sampling point density value sequence. Wherein, the sampling point density value in the sampling point density value sequence may correspond to the initial sampling point with the same serial number in the initial sampling point sequence. The sampling point density value in the sampling point density value sequence may characterize the probability of an object existing at the corresponding sampling point position in the scene. For each initial sampling point in the initial sampling point sequence, perform the following steps:

The first sub-step is to select a sub-initial density grid that matches the above initial sampling point from a sub-initial density grid set included in the initial density grid as a sampling sub-density grid. Wherein, that matches the above initial sampling point may be a sub-initial density grid including the initial sampling point.

The second sub-step is to perform trilinear interpolation on the density value of the sampling sub-density grid to obtain an updated density value.

The third sub-step is to determine the updated density value as a sampling point density value.

Sub-step 4: Based on the initial visual saliency grid included in the initial visual perception radiation field, determine a sampling point visual saliency value corresponding to each initial sampling point in the initial sampling point sequence, to obtain a sampling point visual saliency value sequence. Wherein, the sampling point visual saliency value in the sampling point visual saliency value sequence may correspond to the initial sampling point with the same serial number in the initial sampling point sequence. The sampling point visual saliency value in the sampling point visual saliency value sequence may characterize the visual sensitivity of the corresponding sampling point in the scene. For each initial sampling point in the initial sampling point sequence, perform the following steps:

The first sub-step is to select a sub-initial visual saliency grid that matches the initial sampling point from the sub-initial visual saliency grid set included in the initial visual saliency grid as a sampling sub-visual saliency grid. Wherein, that matches the initial sampling point may be a sub-initial visual saliency grid including the initial sampling point.

The second sub-step is to perform trilinear interpolation on the visual sensitivity feature value of the sampling sub-visual saliency grid, and obtain an updated visual sensitivity value.

The third sub-step is to determine the updated visual sensitivity value as a sampling point visual saliency value.

Sub-step 5: Generate a sampling point feature information sequence based on the sampling point density value sequence and the sampling point visual saliency value sequence. Wherein, the sampling point feature information in the sampling point feature information sequence may include sampling point identifier, sampling point density value, and sampling point visual sensitivity value. For each initial sampling point in the initial sampling point sequence, perform the following steps to generate the sampling point feature information in the sampling point feature information sequence:

The first sub-step is to select a sampling point density value corresponding to the initial sampling point from the sampling point density value sequence.

The second sub-step is to select the sampling point visual saliency value corresponding to the initial sampling point from the sampling point visual saliency value sequence as a sampling point visual sensitivity value.

The third sub-step is to use the spatial point identifier corresponding to the initial sampling point as a sampling point identifier, and determine the sampling point identifier, the selected sampling point density value, and the corresponding sampling point visual sensitivity value as sampling point feature information.

Sub-step 6: Based on the sampling point feature information sequence, determine an initial contrast sensitivity corresponding to the target pixel. The initial contrast sensitivity corresponding to the target pixel may be generated using the following formula set:

$$\{ \begin{matrix}S ( r ) = {\sum }_{i = 1}^{{N}_{1}} {T}_{i} \times ( 1 - exp ( - {σ}_{i} \times {δ}_{i} ) \times {s}_{i} \\ {T}_{i} = exp ( - {\sum }_{j = 1}^{i - 1} {σ}_{j} \times {δ}_{j} )\end{matrix} .$$

Wherein, r represents the number of the ray, S(·) represents the initial contrast sensitivity, S(r) represents the initial contrast sensitivity of the target pixel corresponding to the ray r, i,j both represent the serial numbers, and j is less than i, N₁ represents the maximum serial number in the initial sampling point sequence corresponding to the ray r, T represents cumulative transmittance, reflecting the occlusion of light when it travels to a sampling point, Tᵢ represents the cumulative transmittance of the ray r when it travels to the i^{-th} initial sampling point, that is, the probability of the light ray propagating from the 1^{st} initial sampling point to the i^{-th} initial sampling point without being intercepted, σ represents the density value of the sampling point, σⱼ represents the sampling point density value of the i^{-th} initial sampling point, δ represents the interval between sampling points, S, represents the interval between the i^{-th} initial sampling point and the i+1^{-th} initial sampling point, s represents the sampling point visual sensitivity value, sᵢ represents the sampling point visual sensitivity value of the i^{-th} initial sampling point, σⱼ represents the sampling point density value of the j^{-th} initial sampling point, δⱼ represents the interval between the j^{-th} initial sampling point and the i+1^{-th} initial sampling point, exp(·) represents a natural exponential function.

Step 2: Generate an initial contrast sensitivity map corresponding to the camera image based on various determined initial contrast sensitivities. Firstly, store each initial contrast sensitivity as a pixel value at the corresponding pixel point in the grayscale image, and determine the grayscale image that stores the initial contrast sensitivity as an initial contrast sensitivity map.

The third step is to up-sample the initial contrast sensitivity map to obtain a contrast sensitivity map. Wherein, the contrast sensitivity map may include various contrast sensitivities. The contrast sensitivity map may be a grayscale image with the same resolution as the camera image. The initial contrast sensitivity map may be up-sampled by bilinear interpolation to obtain a contrast sensitivity map.

In practice, after up-sampling the initial contrast sensitivity map, the executing body may restore the initial contrast sensitivity map to the same image resolution as the camera image to be generated, ensuring that the contrast sensitivity map corresponds one-to-one with each pixel in the camera image.

The fourth step is to fuse the visual sensitivity map and the contrast sensitivity map to obtain a visual sampling rate map. The following steps may be executed specifically:

The first sub-step is to perform the following steps for each pixel in the visual sensitivity map to generate a visual sampling rate in the visual sampling rate map:

Sub-step 1: Select a contrast sensitivity that matches the pixel from the contrast sensitivity map as an associated contrast sensitivity. Wherein, that matches the pixel may be that the pixel coordinates corresponding to the contrast sensitivity in the contrast sensitivity map are the same as those of the abovementioned pixels.

Sup-step 2: Determine the visual sensitivity corresponding to the above pixel as an associated visual acuity.

Sub-step 3: In response to determining that the associated contrast sensitivity is greater than or equal to the associated visual sensitivity, determine the associated contrast sensitivity as a visual sampling rate.

Sub-step 4: In response to determining that the associated contrast sensitivity is less than the associated visual sensitivity, determine the associated visual sensitivity as a visual sampling rate.

The second sub-step is to store each obtained visual sampling rate as a pixel value at the corresponding pixel point in the grayscale image, and determine the grayscale image with the stored visual sampling rate as a visual sampling rate map.

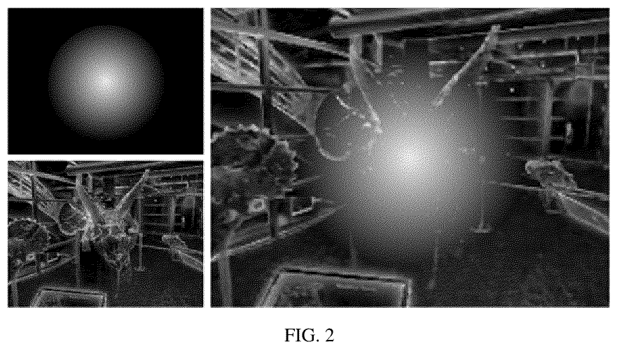

FIG. 2 is a schematic diagram made up of the visual sensitivity map and the contrast sensitivity map generated from a specific perspective, as well as the visual sampling rate map generated by mixing the two, of the efficient rendering method for complex scenes based on visual perception radiation fields according to this disclosure. Wherein, FIG. 2 includes a visual sensitivity map (top left), a contrast sensitivity map (bottom left), and a visual sampling rate map generated by mixing the two (right).

Step 1022: Based on the visual sampling rate map, as well as the initial density grid and initial color grid included in the initial visual perception radiation field, determining an image rendering result corresponding to the sample image.

In some embodiments, the executing body may determine, by various means, an image rendering result corresponding to the sample image based on the visual sampling rate map as well as the initial density grid and initial color grid included in the initial visual perception radiation field. Wherein, the image rendering result may characterize the visual effect of the predicted camera image.

In certain optional implementations of some embodiments, the executing body may determine an image rendering result corresponding to the sample image based on the visual sampling rate map as well as the initial density grid and initial color grid included in the initial visual perception radiation field through the following steps:

The first step is, for each ray in the ray set, perform the following steps:

The first sub-step is to select a visual sampling rate that matches the target pixel from the visual sampling rate map as a target visual sampling rate. Wherein, that matches the target pixel may be that the pixel coordinates corresponding to the visual sampling rate in the visual sampling rate graph are the same as the coordinates of the target pixel.

The second sub-step is to determine a second channel value corresponding to the target pixel based on the importance weight threshold corresponding to the ray and the contrast sensitivity corresponding to the target pixel, and store the second channel value in the contrast sensitivity map. Wherein, the importance weight threshold may be the upper limit value of the importance weight. The importance weight may characterize the importance of sampling points on the ray during the imaging process. The more prominent the pixel features corresponding to the ray, the greater the importance weight corresponding to the ray. The second channel value may be the result of up-sampling the importance weight threshold and the visual sensitivity corresponding to the target pixel together. The second channel value may be stored in the second channel of the target pixel in the contrast sensitivity map.

Alternatively, the importance weight threshold corresponding to the ray may be generated in advance through the following steps:

Step 1: Based on the sampling point feature information sequence corresponding to the ray, determine a sampling point weight value corresponding to each initial sampling point corresponding to the ray, to obtain a sampling point weight value sequence. Wherein, the sampling point weight value characterize the importance of the sampling point in synthesizing the corresponding target pixel. Each sampling point weight value may characterize the importance of the corresponding sampling point in synthesizing the corresponding target pixel. The sampling point weight value corresponding to each initial sampling point may be determined by the following formula:

$${w}_{i} = {T}_{i} \times ( 1 - exp ( - {σ}_{i} \times {δ}_{i} ) ) .$$

Wherein, w represents the weight value, wᵢ represents the sampling point weight value corresponding to the i^{-th} initial sampling point in the initial sampling point sequence.

Step 2: Select the sampling point weight value that meets a preset weight condition from the sampling point weight value sequence as a target importance weight value. Wherein, the preset weight condition may be that the sampling point weight value is the maximum value in the sampling point weight value sequence.

Step 3: Based on the target visual sampling rate and the target importance weight value, generate an importance weight threshold corresponding to the ray. The importance weight threshold corresponding to the ray may be generated using the following formula:

$${τ}_{r} = {w}_{max}^{r} \times ( 1 - {P}_{r} ) .$$

Wherein, τ represents the importance weight threshold, τᵣ represents the importance weight threshold corresponding to the ray r,

$${w}_{max}^{r}$$

represents the target importance weight value corresponding to the ray r, P represents the visual sampling rate, Pᵣ represents the visual sampling rate corresponding to the ray r.

The third sub-step is to generate a sampling limit based on a preset sampling upper limit, a preset sampling lower limit and the target visual sampling rate. Wherein, the sampling upper limit may be the maximum allowed number of samples. The sampling lower limit may be the minimum allowed number of samples. The sampling limit may be the number of limited sampling of points on the ray. The sampling limit may be generated using the following formula:

$${N}_{r} = ⌈ {P}_{r} \times ( {N}_{max} - {N}_{min} ) ⌉ + {N}_{min} .$$

Wherein, N represents the number of samples, Nᵣ represents the sampling limit corresponding to the ray r, max represents the maximum value, min represents the minimum value, Nₘₐₓ represents the upper limit of sampling, Nₘᵢₙ represents the lower limit of sampling, ┌·┐ represents the rounding up operation.

The fourth sub-step is to perform non-uniform sampling of the points on the ray based on the target visual sampling rate, the sampling limit, and the importance weight threshold, to obtain a secondary sampling point sequence. Wherein, the secondary sampling point sequence may be obtained by sampling the points on the above ray for the second time. The following steps may be executed specifically:

Sub-step 1: Based on a preset secondary sampling upper limit and a preset sampling strategy, sample the points on the ray along the direction of ray propagation, and after each sampling is completed, on the basis of the sampling limit and the importance weight threshold, detect the various sampling points obtained by accumulated sampling, to determine whether to terminate the sampling process in advance. Wherein, the secondary sampling upper limit may be the upper limit value of a preset number of sampling points. The preset sampling strategy may be a preset strategy for sampling. The preset sampling strategy may be: If the sampling point weight value corresponding to the current sampling point is greater than the importance weight threshold, continue sampling with a smaller ray propagation step length; otherwise, continue sampling with a larger ray propagation step length. When the number of target sampling points exceeds the sampling limit, the sampling process may be terminated in advance. The target sampling points may be the sampling points that match the importance weight threshold among the various accumulated sampling points obtained during secondary sampling. That matches the importance weight threshold may be that the sampling point weight value corresponding to the sampling point is greater than the importance weight threshold. It should be noted that when the sampled number reaches the secondary sampling upper limit, the sampling stops even if the number of target sampling points is still not greater than the sampling limit.

Alternatively, the ray propagation step length corresponding to the preset sampling strategy may be defined by the following formula:

$${STEP}_{i \to i + 1} = {STEP}_{base} \times exp [ β \times ( 1 - \frac{{w}_{i}}{{τ}_{r}} ) ] .$$

Wherein, STEP represents the ray propagation step length, STEP_{i→i+1} represents the ray propagation step length from the current sampling point to the next sampling point, STEP_{base} represents the preset initial step size, β represents a hyperparameter.

Sub-step 3: In response to determining the termination of the sampling process, determine each sampling point obtained along the direction of ray propagation as a secondary sampling point sequence.

As an example, when the secondary sampling upper limit is 50 and the sampling limit is 30, if the number of samplings has reached 40 times (less than 50) and the number of the target sampling points has reached 31 (greater than 30), the sampling process is terminated in advance, and the total number of the secondary sampling points obtained by secondary sampling is 40. If the number of samplings has reached 50 times, the sampling process is terminated, and the total number of the secondary sampling points obtained from the secondary sampling is 50.

The above steps for generating a secondary sampling point sequence and their related content, as an inventive point of this disclosure, solve the technical problem 2 mentioned in the background section, which is “the rather low quality of the new perspective images synthesized based on the sampled points”. The reasons for the rather low quality of the new perspective images synthesized based on the sampled points are often as follows: the neural radiation field and its variant method typically uses uniform sampling or first coarse then fine sampling to sample points on light rays; the uniform sampling may easily lead to undersampling in visually salient areas, while the first coarse then fine sampling may easily result in oversampling in some visually salient areas. If the above problems are solved, the effect of improving the quality of the synthesized new perspective images may be achieved. To achieve this effect, for each pixel in the camera image to be generated, first, determine the target visual sampling rate and importance weight threshold corresponding to the pixel. Then, perform the sampling based on the target visual sampling rate, and during the sampling process, when the sampling point weight value is greater than the importance weight threshold, use a smaller ray propagation step length to carry out the next sampling step near the surface of the object. Otherwise, use a larger ray propagation step length, skip blank voxels, to quickly reach the surface or boundary of the object. In the end, determine the various sampling points obtained along the direction of ray propagation as a secondary sampling point sequence. Therefore, when guiding the sampling process by the visual sampling rate, it is possible to allocate fewer samples to low visual sensitivity areas and more samples to high visual sensitivity areas according to the visual sensitivity of each pixel corresponding to different areas of the scene. In addition, based on the importance weight threshold, filter out invalid samples that contribute less to the pixel color, and allocate more samples to visible scene objects. Therefore, when synthesizing new perspective images based on sampling points, the quality of the new perspective images may be improved.

The fifth sub-step is to determine the secondary sampling point density value corresponding to each secondary sampling point in the secondary sampling point sequence based on the initial density grid included in the initial visual perception radiation field, to obtain a secondary sampling point density value sequence. Wherein, the secondary sampling point density value in the secondary sampling point density value sequence may correspond to the secondary sampling point with the same serial number in the secondary sampling point sequence. The secondary sampling point density value in the secondary sampling point density value sequence may characterize the probability of an object existing at the position of the corresponding secondary sampling point in the scene. For each secondary sampling point in the secondary sampling point sequence, perform the following steps:
Sub-step 1: Select the sub-initial density grid that matches the secondary sampling point from the sub-initial density grid set included in the initial density grid as a secondary sampling sub-density grid. Wherein, that matches the initial sampling point may be that the sub-initial density grid includes the secondary sampling point.
Sub-step 2: Perform trilinear interpolation on the density value of the sampling sub-density grid to obtain an optimized density value.
Sub-step 3: Determine the optimized density value as a secondary sampling point density value.

The sixth sub-step is to select, one by one, the secondary sampling point that matches the importance weight threshold from the secondary sampling point sequence as a target secondary sampling point, to obtain a target secondary sampling point sequence. Wherein, that matches the importance weight threshold may be that the sampling point weight value corresponding to the secondary sampling point in the secondary sampling point sequence is greater than the importance weight threshold.

The seventh sub-step is, based on the initial color grid included in the initial visual perception radiation field, to determine the secondary sampling point color value corresponding to each target secondary sampling point in the target secondary sampling point sequence, to obtain a secondary sampling point color value sequence. Wherein, the secondary sampling point color value in the secondary sampling point color value sequence may correspond to the secondary sampling point with the same serial number in the secondary sampling point sequence. The secondary sampling point color value in the secondary sampling point color value sequence may characterize the color of the light at the corresponding sampling point in the scene. For each secondary sampling point in the secondary sampling point sequence, perform the following steps:
Sub-step 1: Select a sub-initial color grid that matches the secondary sampling point from the sub-initial color grid set included in the initial color grid as a sampling sub-color grid. Wherein, that matches the secondary sampling point may be that the sub-initial color grid includes the secondary sampling point.
Sub-step 2: Perform trilinear interpolation on the color feature value of the sampling sub-color grid to obtain an optimized color value.
Sub-step 3: Determine the optimized color value as a secondary sampling point color value.

In practice, only when the sampling point weight value corresponding to the secondary sampling point is greater than the importance weight threshold will the various sub-initial color grids be sampled and the color values be calculated. This may reduce unnecessary color synthesis and improve the performance of image rendering.

The eighth sub-step is to generate a pixel color value corresponding to the target pixel based on the secondary sampling point density value sequence and the secondary sampling point color value sequence. Wherein, the pixel color value may be the color value of the target pixel. Each secondary sampling point density value in the secondary sampling point density value sequence may be used as a sampling point density value of the corresponding secondary sampling point, each secondary sampling point color value in the secondary sampling point color value sequence may be used as a sampling point color value of the corresponding secondary sampling point, and the pixel color value corresponding to the target pixel may be generated by the following formula:

$$C ( r ) = {\sum }_{h = 1}^{H} {T}_{h} \times ( 1 - exp ( - {σ}_{h} \times {δ}_{h} ) \times {c}_{h} .$$

Wherein, C(·) represents the pixel color value, h represents the serial number, H represents the maximum serial number of the secondary sampling point sequence corresponding to the ray r, C(r) represents the pixel color value of the target pixel corresponding to the ray r, c represents the sampling point color value, cₕ represents the sampling point color value at the h^{-th} secondary sampling point, Th represents the cumulative transmittance of the ray r when it reaches the i^{-th} secondary sampling point, σₕ represents the sampling point density value of the h^{-th} secondary sampling point, δₕ represents the interval between the h^{-th} secondary sampling point and the h+1^{-th} secondary sampling point.

The ninth sub-step is to determine the contrast sensitivity corresponding to the target pixel as a pixel visual sensitivity.

The tenth sub-step is to determine the pixel color value and the pixel visual sensitivity as a pixel rendering result corresponding to the target pixel.

The second step is to determine the various determined pixel rendering results as an image rendering result corresponding to the sample image.

Step 1023: Based on a preset loss function group, determining a target difference value between the image rendering results corresponding to the sample image and the rendering data of the sample image.

In some embodiments, the executing body may determine a target difference value between the image rendering results corresponding to the sample image and the rendering data of the sample image based on a preset loss function group. Wherein, the rendering data of the sample image may include the sample image and the corresponding visual sensitivity image of the sample image. The loss functions in the above loss function group may be functions used to evaluate from different dimensions the differences between the predicted rendered images and the real rendered images. The target difference value may characterize the difference between the predicted rendered image and the real rendered image.

Alternatively, the loss function group may include a photometric loss function, a visual perception loss function, and an importance weight constraint loss function. Wherein, the photometric loss function may be used to determine the color difference between the image rendering result corresponding to the sample image and the rendering data of the sample image. For example, the photometric loss function may be a mean square error loss function. The visual perception loss function may be used to determine the difference in visual sensitivity between the image rendering result corresponding to the sample image and the rendering data of the sample image. For example, the visual perception loss function may be a mean square error loss function. The importance weight constraint loss function may be used to constrain the density value of the secondary sampling point. Wherein, the importance weight constraint loss function may be expressed by the following formula:

$$\{ \begin{matrix}{L}_{weight} = {\sum }_{r ∈ R} ‖ \frac{1}{{N}_{2}} \times {\sum }_{i = 1}^{{N}_{2}} {f}_{1} ( {w}_{i} , τ ) - ( 1 - τ ) ‖ \\ {f}_{1} ( {w}_{i} , τ ) = \frac{1}{1 + {e}^{- k \times ( {w}_{i} - τ )}}\end{matrix} .$$

Wherein, L_{weight} represents the loss value of the importance weight constraint loss function, R represents the ray set, ∥·∥ represents the first norm, N₂ represents the number of secondary sampling points corresponding to the ray, f₁(·) is a sigmoid function that simulates the process of filtering sampling points in a differentiable form, allowing gradients to propagate backwards, k represents a hyperparameter used to control the rate of change of the function when wᵢ=τ, and when wᵢ<τ, the value of f₁(wᵢ, τ) is 0, and when wᵢ<τ, the value of f₁(wᵢ, τ) is 1. The importance weight constraint loss function may ensure that the weight distribution of all sampling points satisfies the following condition: for each ray, the ratio of the number of all sampling points on the ray to the number of sampling points satisfying w>τ is 1:P, wherein, the P in 1:P is the visual sampling rate of the target pixel corresponding to the ray. It should be noted that, in the importance weight constraint loss function, for each ray r in R, there exists a corresponding N₂, τ, wᵢ, respectively.

In addition, the executing body may determine a target difference value between the image rendering result corresponding to the sample image and the rendering data of the sample image through the following steps:

The first step is to generate a color loss value based on the various pixel color values included in the image rendering result and the sample image included in the rendering data of the sample image through the photometric loss function. Wherein, the color loss value may characterize the color difference between the predicted rendered image and the real rendered image.

The second step is to generate a visual sensitivity loss value based on the various pixel visual sensitivities included in the image rendering result and the visual sensitivity images included in the rendering data of the sample image through the photometric loss function. Wherein, the visual sensitivity loss value may characterize the difference in visual sensitivity between the predicted rendered image and the real rendered image.

The third step is to determine a density loss value corresponding to the image rendering result through the importance weight constraint loss function. Wherein, the density loss value may characterize the difference between the predicted density value and the constrained density value.

The fourth step is to determine the sum of the color loss value, visual sensitivity loss value, and weight loss value as a target difference value.

In practice, the executing body adopts a training method based on importance weight constraints, which may better constrain the solution space of scene geometry and ensure the effectiveness of the sampling strategy in step 1022.

Step 1024: In response to determining that the target difference value is less than a preset difference threshold, determining the initial visual perception radiation field, which has completely training, as a visual perception radiation field.

In some embodiments, the executing body may, in response to determining that the target difference value is less than a preset difference threshold, determine the initial visual perception radiation field that has been trained as a visual perception radiation field. Wherein, the preset difference threshold may be the upper limit value of the preset difference value. The visual perception radiation field may include a density grid, a color grid, and a visual saliency grid. The density grid may be an initial density grid that has been trained. The color grid may be an initial color grid that has been trained. The visual saliency grid may be an initial visual saliency grid that has been trained.

Alternatively, the executing body may also adjust the parameters in the initial visual perception radiation field in response to determining that the target difference value is not less than the preset difference threshold, and select unused scene images from the scene image set as sample images. The adjusted initial visual perception radiation field may be used as an initial visual perception radiation field, and the initial visual perception radiation field training steps may be carried out once again. Wherein, the parameters in the initial visual perception radiation field may be the various feature values stored in the initial density grid, initial color grid, and initial visual saliency grid. By a backpropagation learning method, the parameters in the initial visual perception radiation field may be continuously updated to gradually reduce the target difference value.

Step 103: Inputting the preset rendering perspective information into the visual perception radiation field to output a target rendered image corresponding to the target 3D scene.

In some embodiments, the executing body may input the preset rendering perspective information into the visual perception radiation field to output a target rendered image corresponding to the target 3D scene. Wherein, the rendering perspective information may be the information of a camera pose matrix corresponding to the image to be synthesized. The camera pose matrix may be a matrix representing the position and orientation of the camera. The rendering perspective information has a corresponding ray set. The visual perception radiation field may be based on the ray set corresponding to the rendering perspective information. Firstly, uniformly sample each ray to generate a visual sampling rate map on the basis of the density grid and visual saliency grid. Then, non-uniformly sample each ray on the basis of the visual sampling rate map, to determine the feature value of each sampling point, including a density value and a color value. Thereafter, based on the feature value of each sampling point, and through the pixel color value generation formula, determine the color value corresponding to each pixel in the synthesized image to be synthesized, in order to perform pixel rendering. In the end, output the rendered image to be synthesized as a target rendered image.

Step 104: Controlling an associated display device to display the target rendered image.

In some embodiments, the executing body may control an associated display device to display the target rendered image. Wherein, the display device may be a device with a display screen.

The embodiments of this disclosure have the following beneficial effects: through the efficient rendering method for complex scenes based on visual perception radiation fields in some embodiments of this disclosure, the efficiency and quality of image rendering may be improved, and new perspective images of higher quality may be generated in a timely manner. To be specific, the reason why it is difficult to generate new perspective images of higher quality in a timely manner is that: the neural radiation field and its variant method usually requires a rather long period of network inference during training and operation, and is prone to ignoring significant features around the central visual area, which results in a longer rendering process and lower rendering quality. On this basis, some embodiments of this disclosure propose an efficient rendering method for complex scenes based on visual perception radiation fields. First, constructing an initial visual perception radiation field based on a scene image set obtained in advance corresponding to a target 3D scene, wherein each scene image in the scene image set corresponds to a visual sensitivity image in a visual sensitivity image set, the initial visual perception radiation field includes an initial density grid, an initial color grid, and an initial visual saliency grid. Thus, an untrained initial visual perception radiation field based on a grid structure corresponding to the target 3D scene may be constructed. Then, selecting a scene image from the scene image set as a sample image, and based on the selected sample image, performing the following initial visual perception radiation field training steps: generating a visual sampling rate map based on the user gaze point information corresponding to the selected sample image, as well as the initial density grid and initial visual saliency grid included in the initial visual perception radiation field; based on the visual sampling rate map, and the initial density grid and initial color grid included in the initial visual perception radiation field, determining an image rendering result corresponding to the sample image; based on a preset loss function group, determining a target difference value between the image rendering result corresponding to the sample image and the rendering data of the sample image, wherein the rendering data of the sample image includes the sample image and the visual sensitivity image corresponding to the sample image; in response to determining that the target difference value is less than a preset difference threshold, determining the initial visual perception radiation field, which has completed training, as a visual perception radiation field. Thus, the initial visual perception radiation field may be trained from sample images of multiple perspectives to obtain a visual perception radiation field with higher image rendering quality. Wherein, when training the initial visual perception radiation field based on each sample image, a visual sampling rate corresponding to each pixel in the image to be rendered may be generated based on the sensitivity and gaze point information of the human eye to the scene content. The initial density grid and initial color grid may be sampled based on the visual sampling rate corresponding to each pixel, and a predicted image rendering results may be generated further on the basis of the sampling results. Thereafter, inputting the preset rendering perspective information into the visual perception radiation field to output a target rendered image corresponding to the target 3D scene. Thus, a new perspective image corresponding to the target 3D scene may be generated through visual perception radiation field. In the end, controlling an associated display device to display the target rendered image. Therefore, the efficient rendering method for complex scenes based on visual perception radiation fields in some embodiments of this disclosure may sample a relatively limited number of grids for image rendering during training and operation by constructing in advance a visual perception radiation field based on a grid structure, without spending a rather long time on network inference, thereby shortening the time for image rendering. Moreover, the visual sampling rate used for ray sampling is determined based on visual sensitivity and gaze point information, which may reduce the possibility of the high visual sensitivity area around the gaze point being ignored and improve image rendering quality. Thus, new perspective images of higher quality may be generated in a timely manner.

The technical content not elaborated on in this disclosure belongs to the technology well-known to those skilled in the art.

The above description is merely some preferred embodiments of this disclosure and illustrations of the applied technical principles. Those skilled in the art should understand that the scope of the invention involved in the embodiments of this disclosure is not limited to the technical solutions formed by the specific combination of the above technical features, but should cover at the same time, without departing from the above inventive concept, other technical solutions formed by any combination of the above technical features or their equivalent features, for example, a technical solution formed by replacing the above features with the technical features of similar functions disclosed in (but not limited to) the embodiments of this disclosure.

1. An efficient rendering method for complex scenes based on visual perception radiation fields, comprising:
based on a scene image set obtained in advance corresponding to a target 3D scene, constructing an initial visual perception radiation field, wherein each scene image in the scene image set corresponds to a visual sensitivity image in a visual sensitivity image set generated in advance, the initial visual perception radiation field includes an initial density grid, an initial color grid, and an initial visual saliency grid;
selecting a scene image from the scene image set as a sample image, and based on the selected sample image, performing the following initial visual perception radiation field training steps:
based on user gaze point information corresponding to the selected sample image, as well as the initial density grid and initial visual saliency grid included in the initial visual perception radiation field, generating a visual sampling rate map;
based on the visual sampling rate map, and the initial density grid and initial color grid included in the initial visual perception radiation field, determining an image rendering result corresponding to the sample image;
based on a preset loss function group, determining a target difference value between the image rendering result corresponding to the sample image and rendering data of the sample image, wherein the rendering data of the sample image includes the sample image and the visual sensitivity image corresponding to the sample image;
in response to determining that the target difference value is less than a preset difference threshold, determining the initial visual perception radiation field, which has completed training, as a visual perception radiation field;
inputting a preset rendering perspective information into the visual perception radiation field to output a target rendered image corresponding to the target 3D scene;
controlling an associated display device to display the target rendered image.

2. The method of claim 1, wherein, the method further comprises:
in response to determining that the target difference value is not less than the preset difference threshold, adjusting parameters in the initial visual perception radiation field, and selecting unused scene images from the scene image set as sample images, using the adjusted initial visual perception radiation field as the initial visual perception radiation field, and carrying out the initial visual perception radiation field training steps once again.

3. The method of claim 1, wherein, the constructing an initial visual perception radiation field based on a scene image set obtained in advance corresponding to a target 3D scene includes:
constructing a 3D voxel model based on the scene image set;
determining a first feature grid, a second feature grid, and a third feature grid corresponding to the 3D voxel model;
initializing feature values of the first feature grid to obtain the initial density grid;
initializing feature values of the second feature grid to obtain the initial color grid;
initializing feature values of the third feature grid to obtain the initial visual saliency grid;
determining a model represented by the initial density grid, initial color grid, and initial visual saliency grid as the initial visual perception radiation field.

4. The method of claim 3, wherein, the based on the user gaze point information corresponding to the selected sample image, as well as the initial density grid and initial visual saliency grid included in the initial visual perception radiation field, generating a visual sampling rate map, includes:
based on the user gaze point information corresponding to the sample image, image resolution information corresponding to a preset camera image and a corresponding camera field angle information, constructing a visual sensitivity map, wherein each pixel in the camera image corresponds one-to-one with each ray in a preset ray set;
based on the ray set, as well as the initial density grid and initial visual saliency grid included in the initial visual perception radiation field, constructing an initial contrast sensitivity map;
up-sampling the initial contrast sensitivity map to obtain a contrast sensitivity map, wherein, the contrast sensitivity map includes various contrast sensitivities;
fusing the visual sensitivity map and the contrast sensitivity map to obtain the visual sampling rate map.

5. The method of claim 4, wherein, the constructing an initial contrast sensitivity map based on the ray set, as well as the initial density grid and initial visual saliency grid included in the initial visual perception radiation field includes:
for each ray in the ray set, performing the following steps:
determining a pixel in the camera image that corresponds to the ray as a target pixel;
uniformly sampling points on the ray to obtain an initial sampling point sequence;
based on the initial density grid included in the initial visual perception radiation field, determining a sampling point density value corresponding to each initial sampling point in the initial sampling point sequence, to obtain a sampling point density value sequence;
based on the initial visual saliency grid included in the initial visual perception radiation field, determining a sampling point visual saliency value corresponding to each initial sampling point in the initial sampling point sequence, to obtain a sampling point visual saliency value sequence;
based on the sampling point density value sequence and the sampling point visual saliency value sequence, generating a sampling point feature information sequence;
based on the sampling point feature information sequence,
determining an initial contrast sensitivity corresponding to the target pixel;
based on various determined initial contrast sensitivities, generating the initial contrast sensitivity map corresponding to the camera image.

6. The method of claim 5, wherein, the based on the visual sampling rate map, and the initial density grid and initial color grid included in the initial visual perception radiation field, determining an image rendering result corresponding to the sample image, includes:
for each ray in the ray set, performing the following steps:
selecting a visual sampling rate that matches the target pixel from the visual sampling rate map as a target visual sampling rate;
based on an importance weight threshold corresponding to the ray and a contrast sensitivity corresponding to the target pixel, determining a second channel value corresponding to the target pixel, and storing the second channel value in the contrast sensitivity map;
based on a preset sampling upper limit, a preset sampling lower limit and the target visual sampling rate, generating a sampling limit;
based on the target visual sampling rate, the sampling limit, and the importance weight threshold, performing non-uniform sampling of the points on the ray to obtain a secondary sampling point sequence;
based on the initial density grid included in the initial visual perception radiation field, determining a secondary sampling point density value corresponding to each secondary sampling point in the secondary sampling point sequence, to obtain a secondary sampling point density value sequence;
selecting, one by one, the secondary sampling point that matches the importance weight threshold from the secondary sampling point sequence as a target secondary sampling point, to obtain a target secondary sampling point sequence;
based on the initial color grid included in the initial visual perception radiation field, determining a secondary sampling point color value corresponding to each target secondary sampling point in the target secondary sampling point sequence, to obtain a secondary sampling point color value sequence;
based on the secondary sampling point density value sequence and the secondary sampling point color value sequence, generating a pixel color value corresponding to the target pixel;
determining the contrast sensitivity corresponding to the target pixel as a pixel visual sensitivity;
determining the pixel color value and the pixel visual sensitivity as a pixel rendering result corresponding to the target pixel;
determining various determined pixel rendering results as the image rendering result corresponding to the sample image.

7. The method of claim 6, wherein, the importance weight threshold corresponding to the ray is generated through the following steps:
based on the sampling point feature information sequence corresponding to the ray, determining a sampling point weight value corresponding to each initial sampling point corresponding to the ray, to obtain a sampling point weight value sequence, wherein, the sampling point weight value characterize an importance of the sampling point in synthesizing the corresponding target pixel;
selecting the sampling point weight value that meets a preset weight condition from the sampling point weight value sequence as a target importance weight value;
based on the target visual sampling rate and the target importance weight value, generating the importance weight threshold corresponding to the ray.

8. The method of claim 7, wherein, the loss function group includes a photometric loss function, a visual perception loss function, and an importance weight constraint loss function, the photometric loss function being used to determine a color difference between the image rendering result corresponding to the sample image and the rendering data of the sample image, the visual perception loss function being used to determine a difference in visual sensitivity between the image rendering result corresponding to the sample image and the rendering data of the sample image, and the importance weight constraint loss function being used to constrain a density value of the secondary sampling point.
